(19) United States
(12) Patent Application Publication
(10) Pub. No.: US 2017/0027384 A1
(43) Pub. Date: Feb. 2, 2017

(54) COOKING STAND FOR SKEWERED FOOD ITEMS

(71) Applicant: John Andrew Merriman, Lubbock, TX (US)

(72) Inventor: John Andrew Merriman, Lubbock, TX (US)

(21) Appl. No.: 15/223,805

(22) Filed: Jul. 29, 2016

Related U.S. Application Data
(60) Provisional application No. 62/199,411, filed on Jul. 31, 2015.

(51) Int. Cl. A47J 37/07; A23L 5/10; A23L 19/00; A47J 37/04

(52) U.S. Cl. CPC A47J 37/0786; A47J 37/04; A23L 5/15; A23L 19/05; A23V 2002/00

(57) ABSTRACT

A cooking stand is provided. The cooking stand includes a frame with a plurality of frame members. Each of the frame members includes an elongated support disposed horizontally. A first upright extends vertically from a first end of the elongated support and a second upright extends vertically from a second end of the elongated support. A first notch is formed on an upper edge of the first upright and a second notch is formed on an upper edge of the second upright. The first notch and the second notch align with one another and are disposed directly above the elongated support.

### CROSS-REFERENCE TO RELATED APPLICATION

This application claims the benefit of priority of U.S. provisional application No. 62/199,411, filed Jul. 31, 2015, the contents of which are herein incorporated by reference.

### BACKGROUND OF THE INVENTION

The present invention relates to grilling peppers and, more particularly, to a cooking stand for grilling skewered peppers.

Cooking jalapeno poppers on the grill can be messy. The cheese can melt and run out of the pepper and the peppers can burn easily. Existing products used for grilling jalapeno poopers consist of holes that are used to support the peppers. The pepper must be properly sized to fit within the holes without falling over. Further, existing holders do not protect the bottom of the peppers from direct flames, therefore leaving the bottom of the pepper susceptible to burning.

As can be seen, there is a need for a cooking stand that properly cooks jalapeno poppers and other types of peppers.

### SUMMARY OF THE INVENTION

In one aspect of the present invention, a cooking stand comprises: a frame comprising a plurality of frame members, each frame member comprising:

an elongated support disposed horizontally and comprising a first end and a second end; a first upright extending vertically from the first end, wherein a first notch is formed on an upper edge of the first upright, and a second upright extending vertically from the second end, wherein a second notch is formed on an upper edge of the second upright, wherein the first notch and the second notch align with one another and are disposed directly above the elongated support, wherein each of the elongated supports are substantially parallel relative to one another; a first gap is formed in between each of the elongated supports, wherein the first gap extends along a substantial length of the elongated supports, and the first uprights are adjoined together and the second uprights are adjoined together.

In another aspect of the present invention, a method of grilling a food item comprises: providing a cooking stand comprising: a frame comprising a plurality of frame members, each frame member comprising: an elongated support disposed horizontally and comprising a first end and a second end; a first upright extending vertically from the first end, wherein a first notch is formed on an upper edge of the first upright, and a second upright extending vertically from the second end, wherein a second notch is formed on an upper edge of the second upright, wherein the first notch and the second notch align with one another and are disposed directly above the elongated support, wherein each of the elongated supports are substantially parallel relative to one another; a first gap is formed in between each of the elongated supports, wherein the first gap extends along a substantial length of the elongated supports, and the first uprights are adjoined together and the second uprights are adjoined together; placing the cooking stand on a cooking surface; securing food items to at least one skewer; and placing the skewer within an aligned first notch and second notch.

These and other features, aspects and advantages of the present invention will become better understood with reference to the following drawings, description and claims.

### BRIEF DESCRIPTION OF THE DRAWINGS

FIG. 1 is a front perspective view of an embodiment of the present invention;

FIG. 2 is an exploded perspective view of an embodiment of the present invention;

FIG. 3 is a front perspective view of an embodiment of the present invention in use; and

FIG. 4 is a perspective view of an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a stand used to cook jalapenos and other items on a grill or in the oven. The present invention allows for the use of any sized pepper without worrying that they will fall over and lose their filling. The cooking stand holds the peppers in an upright position, preventing the cheese from dripping out. The legs of the device also protect the peppers from direct flames and help to keep the bottom of the peppers from burning.

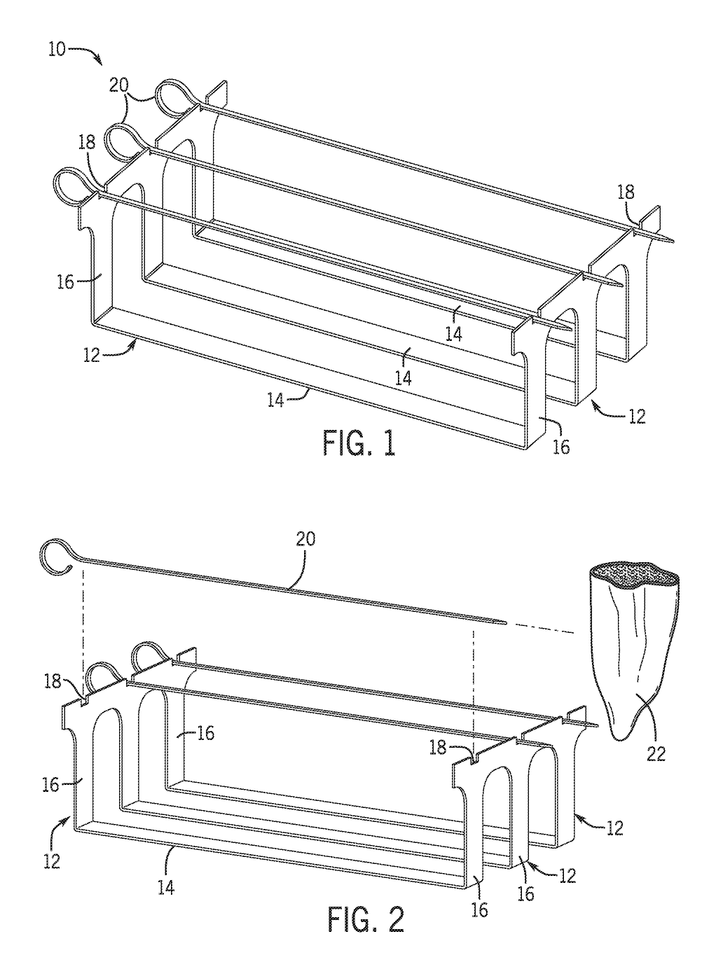

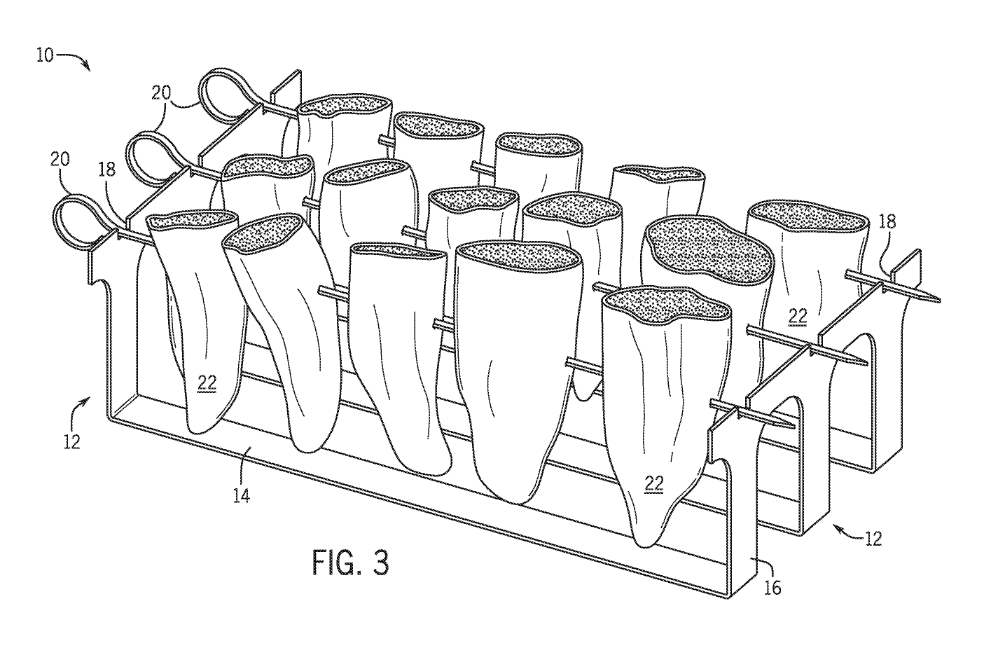

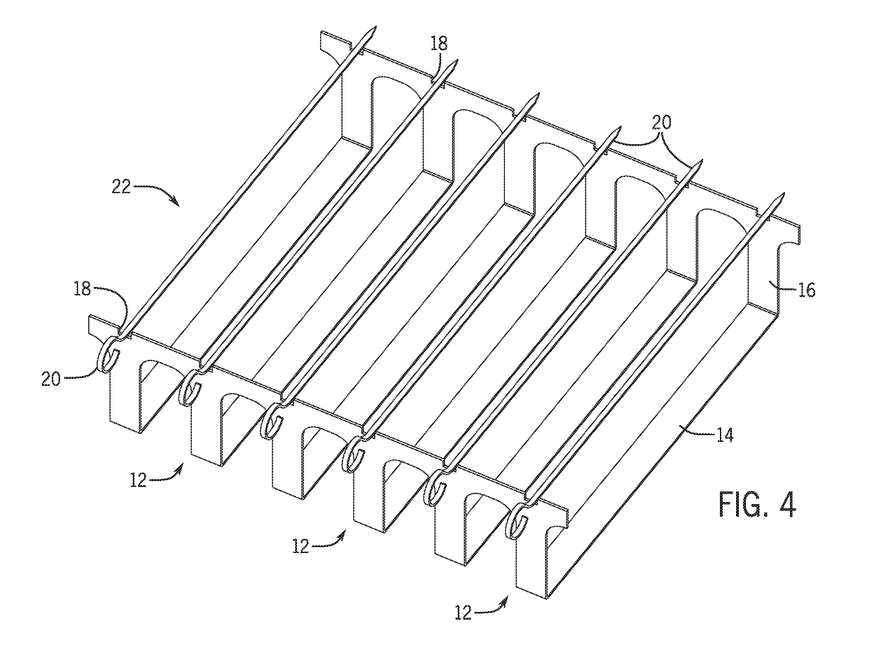

Referring to FIGS. 1 through 4, the present invention includes a cooking stand. The cooking stand includes a frame 10 with a plurality of frame members 12. Each of the frame members 12 includes an elongated support 14 disposed horizontally. A first upright 16 extends vertically from a first end of the elongated support 14 and a second upright 16 extends vertically from a second end of the elongated support 14. A first notch 18 is formed on an upper edge of the first upright 16 and a second notch 18 is formed on an upper edge of the second upright 16. The first notch 18 and the second notch 18 align with one another and are disposed directly above the elongated support 14.

The elongated supports 14 may include a substantially planar bottom surface to rest on a cooking surface, such as a grill or oven and support the frame 10 in an upright position. Each of the elongated supports 14 are substantially parallel relative to one another. A first gap is formed in between each of the elongated supports 14. The first gap extends along a substantial length of the elongated supports 14, from the first end to the second end.

Each of the frame members 12 may support a skewer 20. The skewer 20 rests within the aligned first notch 18 and second notch 18 of the frame members 12. Since the first notch 18 and second notch 18 are directly above the elongated supports 14, the elongated supports 14 may prevent direct flames from hitting the food items 22 disposed on the skewers 20. However, the first gaps allow enough heat and smoke to reach the food items 22 to cook the food items 22 in a preferred amount of time.

The first uprights 16 are adjoined together and the second uprights 16 are adjoined together. The uprights 16 may be adjoined together along a top portion. A second gap may be formed in between each of the first uprights 16 and a third gap may be formed in between each of the second uprights 16. The first, second and third gaps may join together forming a separation between each of the frame members 12, allowing additional heat and smoke to cook the food items 22.

The length of each of the elongated supports 14 may be about six inches up to about eighteen inches. For example, the length of the elongated supports 14 may be about twelve inches, which is a common length for a skewer 20. The height of each of uprights 16 may be about three inches up to about eight inches. The height allows the user to cook stuffed jalapenos by securing the jalapeno to the skewer 20 in an upright and vertical position. Therefore, the stuffing remains within the jalapenos.

The present invention may be made of metal, such as steel. The present invention may be made by cutting with a precision laser machine on a 16 gauge 5 foot by 10 foot sheet of HR steel. The measurements are accurately measured for each stand that is cut out by this machine.

A method of using the present invention may include the following. The user prepares their jalapeno peppers to their desired recipe. The peppers are then skewered about ¾ of the way from the bottom of the peppers to the top of the peppers, allowing the peppers to hang vertically; which keeps the ingredients inside the peppers and prevents them from falling over and spilling. The user then places the skewered peppers on the stand, making sure to utilize the notches on the sides of the stand to keep the skewers in the proper place. The stand is designed to be used on a standard outdoor grill, but it can be placed on a cookie sheet and used in the oven.

It should be understood, of course, that the foregoing relates to exemplary embodiments of the invention and that modifications may be made without departing from the spirit and scope of the invention as set forth in the following claims.

What is claimed is:

1. A cooking stand comprising:
a frame comprising a plurality of frame members, each frame member comprising:
an elongated support disposed horizontally and comprising a first end and a second end;
a first upright extending vertically from the first end, wherein a first notch is formed on an upper edge of the first upright, and
a second upright extending vertically from the second end, wherein a second notch is formed on an upper edge of the second upright, wherein the first notch and the second notch align with one another and are disposed directly above the elongated support, wherein
each of the elongated supports are substantially parallel relative to one another;
a first gap is formed in between each of the elongated supports, wherein the first gap extends along a substantial length of the elongated supports, and
the first uprights are adjoined together and the second uprights are adjoined together.

2. The cooking stand of claim 1, further comprising a plurality of skewers, wherein each skewer is resting within the first notch and the second notch of one of the plurality of frame members.

3. The cooking stand of claim 1, wherein a second gap is formed in between each of the first uprights and a third gap is formed in between each of the second uprights.

4. The cooking stand of claim 1, wherein the length of each the elongated supports is between about six inches and about eighteen inches.

5. The cooking stand of claim 1, wherein a height of each of the first uprights and the second uprights is between three inches about eight inches.

6. The cooking stand of claim 1, wherein each of the elongated supports comprise a substantially planar bottom surface.

7. A method of grilling a food item comprising:
providing a cooking stand comprising:
a frame comprising a plurality of frame members, each frame member comprising:
an elongated support disposed horizontally and comprising a first end and a second end;
a first upright extending vertically from the first end, wherein a first notch is formed on an upper edge of the first upright, and
a second upright extending vertically from the second end, wherein a second notch is formed on an upper edge of the second upright, wherein the first notch and the second notch align with one another and are disposed directly above the elongated support, wherein
each of the elongated supports are substantially parallel relative to one another;
a first gap is formed in between each of the elongated supports, wherein the first gap extends along a substantial length of the elongated supports, and
the first uprights are adjoined together and the second uprights are adjoined together;
placing the cooking stand on a cooking surface;
securing food items to at least one skewer; and
placing the skewer within an aligned first notch and second notch.

8. The method of claim 7, wherein the food items are stuffed jalapenos.

9. The method of claim 7, wherein a second gap is formed in between each of the first uprights and a third gap is formed in between each of the second uprights.

10. The method of claim 7, wherein each of the elongated supports comprise a substantially planar bottom surface.
